(19) United States
(12) Patent Application Publication
(10) Pub. No.: US 2023/0030028 A1
(43) Pub. Date: Feb. 2, 2023

(54) IMPROVED SPECTACLE FRAME

(71) Applicant: BURICCA S.R.L., Arezzo (IT)

(72) Inventors: Francesco Buricca, Arezzo (IT); Lucio Buricca, Arezzo (IT)

(21) Appl. No.: 17/758,456

(22) PCT Filed: Sep. 7, 2020
(86) PCT No.: PCT/IB2020/058315

§ 371 Date: Jul. 6, 2022

(30) Foreign Application Priority Data
Sep. 6, 2019 (IT) 102019000015791

(51) Int. Cl. G02C 5/22

(52) U.S. Cl. CPC G02C 5/2209; G02C 2200/02

(57) ABSTRACT

Described is an eyeglasses frame comprising a front frame supporting a pair of optical lenses, two bars each positioned at a lateral end of the frame, a first magnetic member integral with the front frame and a second magnetic member integral with the bar, the first and second magnetic members being adapted to engage each other in such a way as to guarantee the rotatable connection of the bars to the front frame.

### CROSS-REFERENCE TO RELATED APPLICATIONS

This application is a national phase entry under 35 U.S.C. § 371 of International Patent Application PCT/IB2020/058315, filed Sep. 7, 2020, designating the United States of America and published as International Patent Publication WO 2021/044392 A1 on Mar. 11, 2021, which claims the benefit under Article 8 of the Patent Cooperation Treaty to Italian Patent Application Serial No. 102019000015791, filed Sep. 6, 2019.

### TECHNICAL FIELD

This disclosure relates to an eyeglasses frame.

More specifically, the disclosure relates to an eyeglasses frame in which the side bars are removably connected by a hinge system of the magnetic type.

### BACKGROUND

More and more people wear eyeglasses, both for sight and protection, such as, for example, sunglasses.

Since this is an accessory that the user often cannot avoid, the eyeglasses are consequently exposed to a plurality of activities, on both a daily and occasional basis, that can potentially cause damage both to the lenses and to the front frame to which the lenses are connected.

Many people will have taken off their eyeglasses and, for example, then accidentally sat on them, or rested something heavy on them, making it possible to deform the structure or, even worse, break it.

Sometimes, just simply falling asleep with the eyeglasses on and moving while asleep can place them against a rather rigid body that may adversely affect their normal shape.

A part of the eyeglasses that is often a critical problem consists of the hinges connecting the bars (or arms) to the actual front frame that supports the lenses.

In effect, it is a fundamental part of the frame of the eyeglasses since it must guarantee the possibility of reducing the overall dimensions of the eyeglasses that, in the configuration of use, that is to say, with the bars open, would be extremely awkward to position and bulky to be stored.

At the same time, the above-mentioned hinges must allow an easy folding of the bars but at the same time also maintain a stable opening position, that is to say, when the eyeglasses are worn by the user.

The universally widespread solution for making these hinges comprises two hinge elements that are rotatably engaged and stably connected to each other by means of an extremely small screw, also defining the fulcrum of the hinge.

The drawbacks of these small screws are known to all the users of eyeglasses, since, as well as their threaded part very often not being very durable (leading to the annoying loosening of the hinge joint between the bars and the rest of the front frame of the eyeglasses), are also difficult to handle and replace, making repairs not particularly easy even for professional opticians.

A solution that fully resolves the above-mentioned drawbacks of the frames of eyeglasses with connection of the bars of known type has so far not been found.

For example, patent document US 2010/0309425 teaches the making of magnetic connections between various components of the eyeglasses, including the bars, that are, therefore, connected to the front frame by a hinge of the magnetic type that allows them to be easily detached once a force greater than that of magnetic attraction is applied between the two magnets used, respectively, on the bar and on the front frame of the eyeglasses.

Although the solution just described has partly addressed some of the above-mentioned problems, it has not been seen to be completely free from drawbacks.

The above-mentioned drawbacks include, for example, the fact that in order to guarantee an adequate magnetic connection between the bars and the front frame, the dimensions of the magnets might not be negligible and, as such, have a negative effect on, or in any case greatly affect, the design of the eyeglasses.

Another drawback of the solution described above is due to the rubbing of the magnets caused by the opening/closing of the bars of the eyeglasses. In effect, this rubbing causes rapid deterioration of the magnets themselves, which, in particular, if made of neodymium, easily tend to break up once the surface protective layer has been consumed, precisely as a result of rubbing.

Yet another drawback, again linked to the deterioration of the magnets, is due to the impacts between the magnets themselves each time they are joined to connect the bars to the front frame. It is often the case that after a certain number of joinings, the joinings irreversibly damage the magnets.

### BRIEF SUMMARY

The aim of this disclosure is to provide a frame for eyeglasses that is able to overcome the drawbacks of the prior art and that is at the same time practical to use and simple to make.

A further aim of the disclosure is to provide an eyeglasses frame that does not deteriorate rapidly with use.

According to the disclosure, these aims and others are achieved by an eyeglasses frame comprising the technical features described in the appended claims.

### BRIEF DESCRIPTION OF THE DRAWINGS

The technical features of the disclosure, with reference to the above-mentioned aims, are clearly described in the appended claims and its advantages are apparent from the detailed description that follows, with reference to the accompanying drawings that illustrate a nonlimiting example embodiment of the disclosure and in which:

FIG. 1 is a schematic perspective view of a preferred embodiment of a frame for eyeglasses made in accordance with the disclosure;

FIG. 1A is a rear schematic perspective view with exploded elements of a detail of the frame of FIG. 1;

FIG. 1B is an enlarged view of the circled detail of the component of FIG. 1A;

FIG. 2 is a schematic perspective view with exploded elements of a different detail of the frame of FIG. 1;

FIG. 2A is an enlarged view of the circled detail of the component of FIG. 2;

FIG. 3 is a schematic perspective view from below of the set of components of FIGS. 1A and 2 with exploded details;

FIG. 3A illustrates the assembly of FIG. 3 in an assembled configuration;

FIG. 4 is a schematic perspective rear view of the detail of FIG. 1A with the elements assembled, previously shown exploded;

FIG. 4A is an enlarged view of the circled detail of the component of FIG. 4;

FIG. 5 is a schematic perspective view of the detail of FIG. 2 with the elements assembled, previously shown exploded;

FIG. 5A is an enlarged view of the circled detail of the component of FIG. 5;

FIG. 6 is a schematic side elevation view of the trend of the magnetic field resulting from the superposing of two permanent magnets according to the prior art;

FIG. 7 is a schematic side elevation view of the trend of the magnetic field resulting from the superposing of two permanent magnets made according to the disclosure;

FIG. 8 is a rear schematic perspective view of a detail of a variant embodiment of the eyeglasses frame according to the disclosure; and

FIGS. 9 and 10 are respective rear schematic perspective views of two different configurations of a detail of a further variant embodiment of the eyeglasses frame according to the disclosure.

### DETAILED DESCRIPTION

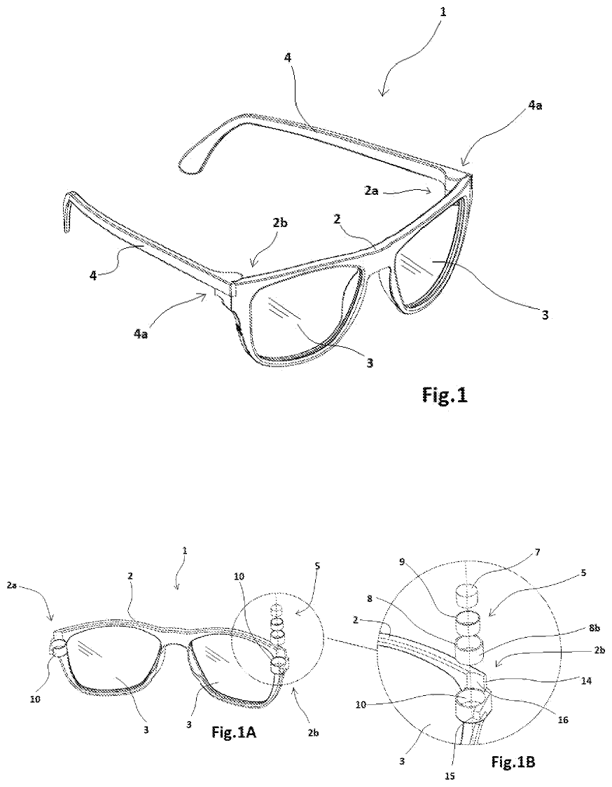

As illustrated in FIG. 1, the numeral 1 denotes in its entirety a preferred embodiment of the eyeglasses frame made according to the disclosure.

The frame 1 comprises a front frame 2 supporting two optical lenses 3 and two bars 4, commonly also called arms, each located at a respective lateral end 2a, 2b of the front frame 2.

The concept of two optical lenses, for the purposes of the disclosure, is intended to also include the solution, not illustrated, of a single lens that extends continuously until covering the area designed to be captured by both the eyes of the user.

The front frame 2 is advantageously made of plastic material.

The bars 4 are advantageously made of plastic material. Materials alternative to the plastic material for the making of the frame 2 and/or the bars 4 are metals or wood and its derivatives.

For the purpose of connecting the bars 4 to the front frame 2, the frame 1 comprises a first magnetic member 5 supported by the frame 2 and a second magnetic member 6 supported by each bar 4.

The above-mentioned first and second magnetic members 5, 6 are designed to engage mutually with each other as a result of the respective magnetic attraction force to guarantee the rotatable connection of the bars 4 relative to the front frame 2.

Advantageously, the two first and second magnetic members 5, 6 are identical and interchangeable.

The concept of equality just expressed naturally takes into account their reversed polarity in order to generate reciprocal magnetic attraction.

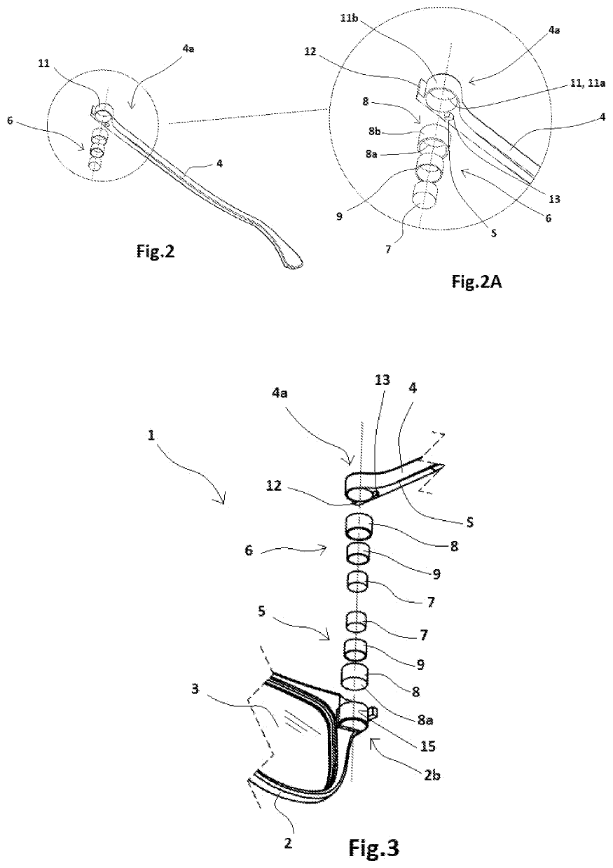

As clearly illustrated in FIGS. 1B and 2A, each first and second magnetic member 5, 6 comprises an inner cylindrical core 7 made of ferromagnetic material and an outer capsule B for containing the inner cylindrical core 7.

The inner cylindrical core 7 is advantageously made from one of the alloys of neodymium-iron-boron and samarium-cobalt, due to the favorable ratio that both these alloys have between the magnetic attraction force exerted and the volume of the magnet relative to other ferromagnetic materials.

The outer coaxial capsule 8 is made of a material with a high magnetic permeability.

The expression “high magnetic permeability” is used in this description to mean a magnetic permeability whose value is greater than or equal to that of nickel, that is to say, equal to or greater than 1.25×10⁻⁴μ [H/m].

By way of example, the outer capsule 8 is made of steel. The outer capsule 8 is cylindrical in shape and has a bottom wall 8a and a lateral cylindrical wall 8b.

The lateral cylindrical wall 8b has a circumferential end edge 8c.

The outer capsule 8 is configured to coaxially contain, inside it, the inner cylindrical core 7, without it protruding in an axial direction (that is, in the direction of the axis of any of the coaxial cylinders defined by the core 7 or the capsule 8) beyond the above-mentioned circumferential end edge 8c of the lateral cylindrical wall 8b.

Advantageously, the above-mentioned circumferential end edge 8c of the lateral cylindrical wall 8b protrudes axially relative to the maximum axial height of the inner cylindrical core 7.

This limited protrusion is an excellent compromise since, in the assembled frame, it is thus possible to bring the respective inner cores 7 of the two magnetic members 5, 6 practically into contact, thereby maximizing the magnetic attraction force exerted between them, but at the same time preventing, during the rotation of the magnetic members 5, 6 connected to the movement of the bars 4, the two inner cores 7 from breaking up, wearing, as described in more detail below. Further, the above-mentioned protrusion also prevents the impact that would occur between the inner cylindrical cores 7 of the two magnetic members 5, 6 each time the connection between the bars 4 and the front frame 2 occurs, which, as mentioned above, is able to damage the integrity of the inner cylindrical cores 7.

The above-mentioned projection, made in both the above-mentioned magnetic members 5, 6 determines, in use, a mutual distance between the two respective inner cores 7.

Advantageously, the distance is between 0.01 mm and 0.6 mm.

Still more advantageously, in use, the above-mentioned distance between the respective cores of the magnetic members 5, 6 is between 0.05 mm and 0.4 mm.

Experimental tests have shown that an optimum value of this distance is approximately 0.15 mm.

Again with reference to FIGS. 1B and 2A, each of the above-mentioned first and second magnetic members 5, 6 comprises a respective sleeve 9 for covering the inner core.

The covering sleeve 9 is interposed between the inner cylindrical core 7 and the outer capsule 8.

Advantageously, the covering sleeve 9 has a thickness of between 0.05 mm and 0.4 mm.

This thickness is to be considered in a diametric direction, that is to say, according to any diameter of the inner cylindrical core 7 or of the outer coaxial capsule 8.

Still more advantageously, the covering sleeve 9 has a thickness of between 0.1 mm and 0.35 mm.

Experimental tests have shown that an optimum value of this thickness is approximately 0.3 mm.

The covering sleeve 9 is advantageously made of plastic material.

According to a preferred embodiment, the covering sleeve 9 is made of rubbery plastic material melted around the inner core 7.

Alternatively, the covering sleeve 9 is formed by a layer of glue used to stably connect the inner cylindrical core 7 to the outer coaxial capsule 8.

Advantageously, the covering sleeve 9 allows the inner core 7 to be stably inserted inside the outer capsule 8. The inner cylindrical core 7, particularly if it is made of a neodymium-iron-boron alloy, is, in fact, fragile and tends to break down following even limited surface wear.

The covering sleeve 9 advantageously protects the inner core 7 from impacts and/or abrasions, thus contributing to maintaining its integrity for a long time and increasing its efficiency.

Advantageously, according to a variant embodiment not illustrated in the accompanying drawings, the covering sleeve 9 completely covers the inner cores 7, in such a way as to actively act against the above-mentioned harmful impacts and abrasions between the inner cores 7. The above-mentioned covering sleeve 9, including the covering layer of the respective surfaces facing each other of the two inner cores 7, as well as protecting the cores has the useful function of preventing direct contact of the user with the inner core 7 since this is normally covered with nickel, a metal to which an increasingly greater number of persons are allergic.

As illustrated in FIG. 1A, and in more detail in FIG. 1B, at each relative lateral end 2a, 2b, the front frame 2 has respective first cylindrical seats 10 for housing respective first magnetic members 5.

With reference to FIGS. 2 and 2A, at the abovementioned connecting zone 4a, each bar 4 has a second cylindrical seat 11 for housing the above-mentioned second magnetic member 6.

The above-mentioned second cylindrical seat 11 has an inner cylindrical cavity 11a for housing the second magnetic member 6.

The above-mentioned second cylindrical seat 11 has an outer wall 11b having at least for part of its extension, a cylindrical shape coaxial with the above-mentioned inner cylindrical cavity 11a.

As illustrated in FIG. 2A, on each of the two bars 4 there are, at the respective zone 4a for connection to the front frame 2, a first stop element 12 and a second stop element 13.

The two first and second stop elements 12, 13 are separate and spaced from each other.

With reference to FIG. 2A, the first stop element 12 protrudes in a fin-like fashion, projecting from the bar 4 tangentially relative to a cylindrical surface defined by the above-mentioned outer wall 11b of the second cylindrical seat 11, the cylindrical surface being coaxial with the inner cylindrical core 7 of the second magnetic member 6.

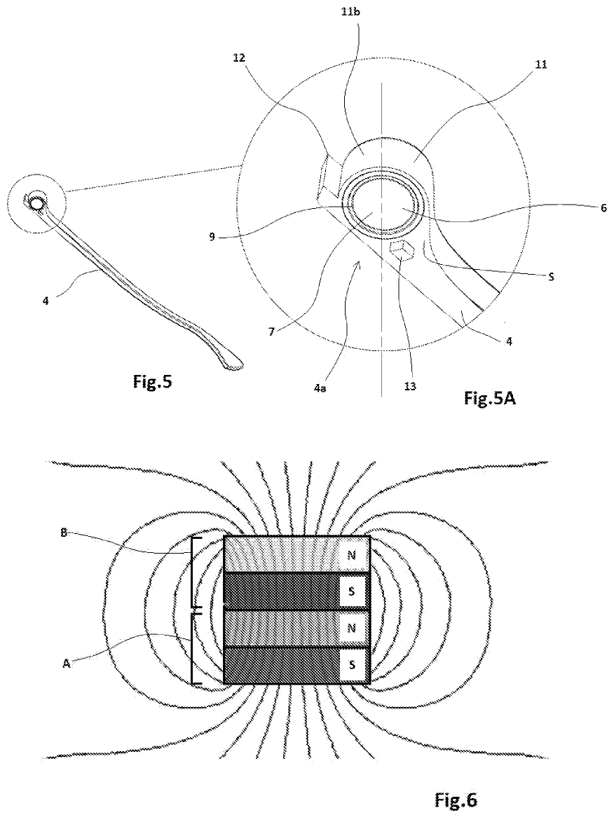

As illustrated in FIG. 5A, the above-mentioned second stop element 13 protrudes below the bar 4, in the direction of the axis of the inner cylindrical core 7 of the second magnetic member 6, beyond the overall dimensions of the outer containment capsule.

In other words, the portion 4a of the bar 4 has a substantially flat lower surface S and the second stop element 13 protrudes relative to that surface.

The second stop element 13 is shown in the accompanying drawings purely by way of example in the form of a substantially parallelepiped block but other different shapes may be equivalent to it.

As illustrated in FIG. 1B, on the front frame 2 there are, at each of its lateral ends 2a, 2b for engaging with the bars 4, a first contact element 14 and a second contact element 15.

The first and second stop elements 12, 13 are designed to engage in contact, respectively, with the above-mentioned first and second contact elements 14, 15.

The above-mentioned engagement in contact of the first and second stop elements 12, 13 with the respective first and second contact elements 14, 15, is simultaneous, thereby generating a pair of forces opposing an extra opening of the bars 4.

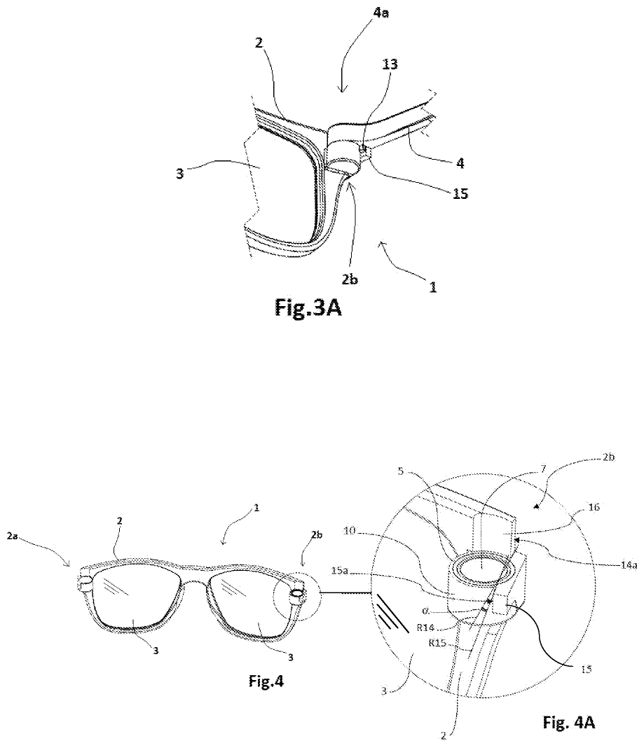

In other words, the pair of forces generated in the contact of the above-mentioned stop elements 12, 13 is such as to oppose a rotation of the bar 4 relative to the front frame 2, which goes beyond the condition of normal opening provided for the bar 4 and, in angular terms, substantially shown in FIG. 3.

The first and second stop elements 12, 13, with the respective first and second contact elements 14, 15, define, in their entirety, for the frame 1, means for limiting the reciprocal rotation of the first and second magnetic members 5, 6.

As illustrated in FIG. 4A, the first contact element 14 and the second contact element 15 have respective flat contact surfaces 14a, 15a whose planes intersect, forming an angle α.

Again, with reference to FIG. 4A, the above-mentioned planes are represented by two respective straight lines R14, R15, which represent the tracks relative to a top plan view.

The angle α formed by the two planes and represented by the two straight lines R14 and R15 is advantageously between 0 sexagesimal degrees and 25 sexagesimal degrees.

Still more advantageously, the angle α is between 5 sexagesimal degrees and 15 sexagesimal degrees.

According to an optimum embodiment, the angle α is approximately 10 sexagesimal degrees.

The above-mentioned values of the angle α have been found experimentally to be optimum for the purpose of an effective detachment of the bar 4 from the front frame 2 following a stress on the bar 4.

The above-mentioned first magnetic member 5 and second magnetic member 6, together with the relative means for limiting the reciprocal rotation, define, for the frame 1 means for connecting the bars 4 to the front frame 2, configured to allow the bars 4 to rotate relative to the front frame 2 at least between a first open position wherein the bars 4 are designed to rest on the ears of a user for wearing the eyeglasses, and a second closed position wherein the bars 4 are folded close to the front frame 2 to reduce the overall dimensions of the frame 1.

As illustrated in FIG. 5A, a portion of the abovementioned outer wall 11b with a cylindrical shape and coaxial with the inner cylindrical cavity 11a defines a first convex cylindrical portion designed to engage with a second concave cylindrical portion 16 made, on the other hand, in the frame 2, at each relative lateral end 2a, 2b.

Once the bar 4 is mounted on the front frame 2, the first and second cylindrical portions 11b, 16 are coaxial with each other and are configured to engage by sliding during the movement of the bars 4 between their first open position and second closed position.

The above-mentioned first convex and second concave cylindrical portions 11b, 16 together define, for the frame 1, means for guiding the reciprocal rotation of the bar 4 relative to the front frame 2.

With reference to the variant embodiment illustrated in FIG. 8, in it the first and second cylindrical seats 10, 11 for housing the respective magnetic members 5, 6 are shaped in the form of cylindrical cams in such a way as to provide a predetermined resistance in specific angles during the relative rotation of the bar 4 relative to the front frame 2.

This resistance is offered by the magnetic attraction force exerted between the two magnetic members 5, 6 that oppose their movement away induced by the protrusions present on the cylindrical cam.

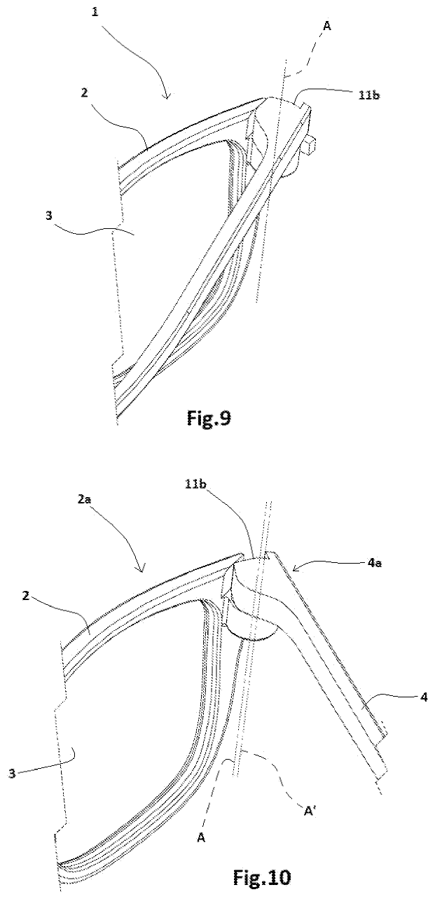

FIGS. 9 and 10 illustrate, in two different configurations of use, a further variant embodiment of the frame 1 according to the disclosure. In this variant embodiment, the outer wall 11b does not have a cylindrical shape but has a lateral cam profile, in such a way as to form, in its sliding engagement on the second concave cylindrical portion 16, a momentarily limited offset between the respective axes A and A′ of the magnetic members 5, 6.

This offset is opposed by the magnetic attraction exerted between the two magnetic members 5, 6 that, due to the particular shape, naturally tend to remain coaxial.

The above-mentioned actions described with reference to the embodiments of FIGS. 8 to 10 are designed to guarantee the maintaining of stable positions for opening/closing the bars 4 relative to the frame 2.

In use, the frame 1 of the eyeglasses according to the disclosure allows practical and effective connection between the bars 4 and the front frame 2.

FIG. 6 schematically shows the trend of the magnetic field that is created between two generic permanent magnets A, B of known type with their opposite facing poles.

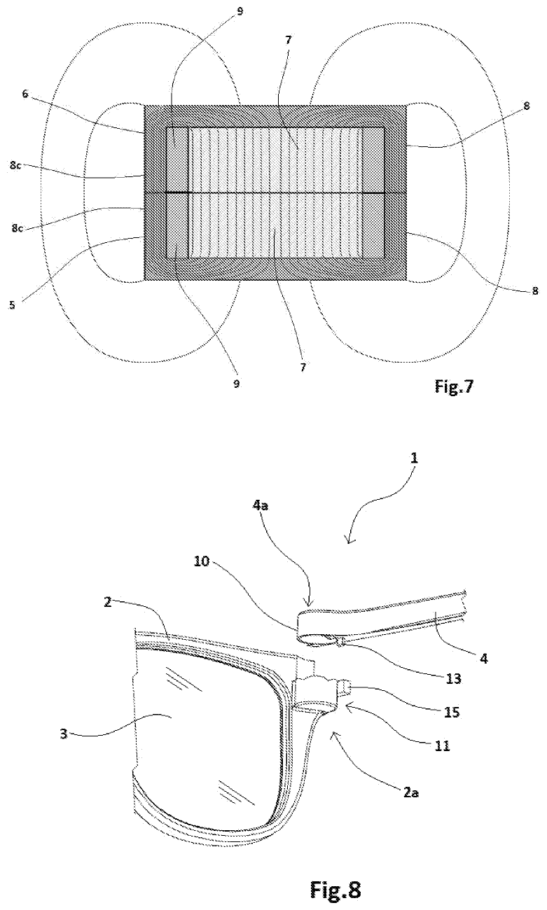

FIG. 7 schematically shows the trend of the magnetic field that is established between two magnetic members 5, 6 according to the disclosure, with their opposite poles facing each other and also with the outer coaxial capsules 8, made of material with a high magnetic permeability, substantially in contact with the respective circumferential end edges 8c.

It has been seen experimentally that thanks to the architecture of the magnetic members 5, 6 and their specific mode of interaction, the resulting magnetic field, as illustrated in FIG. 7, is particularly efficient in guaranteeing an effective magnetic attraction force between the two magnetic members 5, 6 and consequently between the front frame 2 and the two bars 4 connected to it.

More specifically, the resulting magnetic field, as illustrated schematically in FIG. 7, appears very concentrated in the area occupied by the two cylindrical magnetic members 5, 6, thus limiting dispersion to the outside of them, as happens in the prior art case illustrated in FIG. 6.

The presence, in the magnetic field of FIG. 6, of numerous flow lines outside the magnetic cores implies a sort of relative dispersion, unlike that which occurs in the configuration according to the disclosure, illustrated in FIG. 7. In the latter, the concentration of the flow lines inside the space occupied by the magnetic members 5, 6 results in a better use of the magnetic field generated by the two magnetic members 5, 6, with an effective maintaining of a sort of “pivoted” configuration between the bars 4 and the front frame 2, almost as if there were a mechanical hinge.

In order to achieve the above-mentioned optimum concentration of the magnetic field “inside” the space occupied by the magnetic members 5, 6 it is important that there is a discontinuity between the inner core 7 and the outer capsule 8, in particular with reference to the lateral cylindrical surface of separation between the two parts.

This discontinuity may be occupied, entirely or partly, by the sleeve 9, irrespective of whether the latter is made of plastic material or is defined by the adhesive used for stably fixing the inner cores 7 to the respective outer capsules 8.

The eyeglasses frame 1, according to the disclosure, therefore, overcomes the above-mentioned drawbacks and brings important advantages.

It has been found experimentally that the thickness of the above-mentioned discontinuity does not exert an adequate screening action either when it is too small or when it is very high.

A first advantage linked to the frame of the eyeglasses, according to the disclosure, is due to the fact that, thanks to the above-mentioned particular architecture and arrangement of the magnetic members it has been possible to obtain a stable connection without the need to increase the dimensions of the magnetic members used.

A further advantage linked to the disclosure is due to the fact that, thanks to the covering sleeve applied to the inner cylindrical core made of ferromagnetic material, the life of the latter is considerably increased, even more so if the core is made of neodymium.

A further advantage linked to the disclosure is due to the fact that the two inner cores made of ferromagnetic material of each “hinge” are suitably spaced from each other in such a way as not to generate rubbing or even simply impacts during their reciprocal movements.

It has been found experimentally that the distances claimed and described are optimum since they create the best compromise between, on the one hand, the need to keep the cores detached in order to protect them against impacts and rubbing, and, on the other hand, the need to have a good vicinity so as not to adversely affect the magnetic attraction between the two cores.

A further advantage linked to the disclosure is the optimum reciprocal angle of the flat contact surfaces 14a, 15a of the first and second contact elements 14, 15. Thanks to this ideal inclination, the resistance to detachment of the bar 4 is optimized when the bar 4 engages the respective first stop element 12 and second stop element 13 in these contact elements.

In other words, thanks to the above-mentioned optimum inclination there is an effective retaining of the bar at the detachment but it allows the detachment when the force acting could determine irreversible damage of the parts.

In short, the bar 4 is stably connected to the frame but if the force applied is excessive then it is detached in such a way as not to damage the frame.

Yet another advantage of the eyeglasses frame according to the disclosure is due to the particular magnetic field being concentrated in the axial zone of the magnetic members and limiting its effectiveness substantially in the axial extension of the cores does not exert particular attraction against metal parts that could come into contact with the frame itself

Indeed, it is possible to place the eyeglasses frame in a bag where there are metallic objects such as keys, coins, etc., and, as a result of the eyeglass frame solution according to the disclosure, these objects will not be effectively attracted by the magnetic members located between the front frame and the bars.

1.-14. (canceled)

15. An eyeglasses frame, comprising:
a front frame for supporting two optical lenses,
two bars each positioned at a side end of the front frame,
connecting members for connecting the bars to the front frame, configured to allow the bars to move rotatably relative to the front frame at least between a first open position wherein the bars are designed to rest on a user's ears for wearing the eyeglasses frame, and a second closed position wherein the bars are folded close to the front frame for reducing overall dimensions of the eyeglasses frame, the connecting members comprising for each bar a respective first magnetic member integral with the front frame and a respective second magnetic member integral with each bar itself, the first and second magnetic members being designed to engage with each other to guarantee rotatable connection of the bars to the front frame, wherein each of the first and second magnetic members comprise an inner cylindrical core made of ferromagnetic material and an outer capsule containing the inner cylindrical core, the outer capsule being made of material with high magnetic permeability and wherein the inner cylindrical core of the first and second magnetic members are positioned in sufficient proximity to secure the members during rotation of the bars relative to the front frame.

16. The eyeglasses frame according to claim 15, wherein at least one of the bars comprises a body incorporating a cylindrical recess for receiving the outer capsule of the second magnetic member, the outer capsule of the second magnetic member having a first extremity and a second extremity opposite to the first extremity, the first extremity being wholly covered by the body while the second extremity is exposed; and the front frame comprises a body forming a further cylindrical recess for receiving the outer capsule of the first magnetic member, the outer capsule of the first magnetic member having a first extremity and a second extremity opposite to the first extremity, the first extremity being wholly covered by the body while the second extremity is exposed, whereby exposed portions overlap, in use, to allow the bars to remain connected to the front frame during rotation between the first open position and the second closed position.

17. The eyeglasses frame according to claim 15, wherein at least one of the first and second magnetic members comprise a protective covering layer covering the respective inner cylindrical core.

18. The eyeglasses frame according to claim 15, wherein, in use, the inner cylindrical cores of the first and second magnetic members are spaced from one another by a distance of between 0.01 mm and 0.6 mm.

19. The eyeglasses frame according to claim 18, wherein the distance between the inner cylindrical cores of the first and second magnetic members is between 0.05 mm and 0.4 mm.

20. The eyeglasses frame according to claim 19, wherein the distance between the inner cylindrical cores of the first and second magnetic members is approximately 0.15 mm.

21. The eyeglasses frame according to claim 15, wherein each of the first and second magnetic members comprises a sleeve for covering the cylindrical inner core, the covering sleeve being interposed between the cylindrical inner core and the outer capsule.

22. The eyeglasses frame according to claim 21, wherein the covering sleeve is made of plastic material.

23. The eyeglasses frame according to claim 22, wherein the covering sleeve has a thickness of between 0.05 mm and 0.4 mm.

24. The eyeglasses frame according to claim 15, wherein the outer capsule is cylindrical in shape and has a bottom wall and a lateral cylindrical wall and is configured to coaxially contain, inside the outer capsule, the inner cylindrical core, without the inner cylindrical core protruding in an axial direction beyond an end edge of the lateral cylindrical wall.

25. The eyeglasses frame according to claim 24, wherein the end edge of the lateral cylindrical wall protrudes axially with respect to the inner cylindrical core.

26. The eyeglasses frame according to claim 15, wherein the inner cylindrical core made of ferromagnetic material is made of an alloy chosen from neodymium-iron-boron and samarium-cobalt.

27. The eyeglasses frame according to claim 15, wherein the connecting members for connecting the bars to the front frame are configured to limit reciprocal rotation of the first magnetic member and second magnetic member, wherein the front frame further comprises a. first stop element protruding away from the front frame and in substantially the direction of a wearer's ear, the bars comprising a second stop element protruding down from the bars and configured to abut the first stop element when the bars are rotated into their substantially fully open position.

28. The eyeglasses frame according to claim 27, wherein the front frame comprises a third stop extending upwards from the front frame and the bars comprise a fourth stop projecting forward from an axial direction of the bars, whereby the third and fourth stops engage one another when the bars are rotated into their substantially fully open position.

29. The eyeglasses frame according to claim 28, wherein the first, second, third and fourth stops are configured to engage each other when the bars are rotated into their substantially fully open position.

30. The eyeglasses frame according to claim 28, wherein the fourth stop projects from the bars tangentially relative to a cylindrical surface coaxial with the inner cylindrical core of the second magnetic member.

31. The eyeglasses frame according to claim 27, wherein the second stop element protrudes downward from the bars in the direction of an axis of the inner cylindrical core of the second magnetic member, beyond the overall dimensions of the outer capsule.

32. The eyeglasses frame according to claim 27, wherein the first and second contact elements have respective flat contact surfaces whose planes intersect each other to form an angle α, wherein the angle is between 0 sexagesimal degrees and 25 sexagesimal degrees.

33. The eyeglasses frame according to claim 15, wherein each of the bars comprises a first convex cylindrical portion and the front frame comprises a second concave cylindrical portion, the first convex and second concave cylindrical portions being coaxial with each other and configured to slide during movement of the bars from their the first open position and their the second closed position and vice versa.
